(19) United States
(12) Patent Application Publication
(10) Pub. No.: US 2017/0032611 A1
(43) Pub. Date: Feb. 2, 2017

(54) Electronic Gaming Machine And Gaming Method

(71) Applicant: Ainsworth Game Technology Limited, Newington (AU)

(72) Inventors: Joseph Luong, Plumpton (AU); Peter Scott Clarebrough, Sydney (AU)

(21) Appl. No.: 14/826,531

(22) Filed: Aug. 14, 2015

(30) Foreign Application Priority Data
Jul. 28, 2015 (AU) 2015207846

(51) Int. Cl. G07F 17/32

(52) U.S. Cl. CPC G07F 17/3213; G07F 17/3258; G07F 17/3267

(57) ABSTRACT

The invention provides an electronic gaming machine comprising a display for displaying a game comprising game positions arranged into a plurality of reels. The appearance of special game symbols in the game positions of at least a predetermined number of reels causes an electronic game controller to award a bonus prize, said bonus prize being dependent on the number of reels that display the special game symbols in each of their respective game positions. A gaming method is also provided.

### BACKGROUND

Conventional gaming machines typically involve awarding prizes to a player according to predetermined combinations of game symbols that appear on an array of game squares displayed on a screen, typically organised into three rows and five columns (commonly called a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may also be provided by an electronic gaming machine in addition to a base or main game. Typically feature games use the same set of reels as the main game and are limited to a set of free games operated under a single set of rules. This means that the feature game is restricted by the same set of rules, and so there is no variation in the play of the feature game.

Also, electronic gaming machines can offer one or more bonus prizes to the player during play of the game. The most common type of bonus prize that is awarded by the electronic gaming machine is a jackpot prize, the main example of which is a progressive jackpot prize.

This standard structure to game play and bonus prizes limits the variation in the play of the electronic gaming machine. Consequently, it is difficult to retain player interest because there is no apparent incentive for the player to continue playing the same electronic gaming machine once the player becomes familiar with the feature game, the main game and any bonus prizes. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

### SUMMARY

According to a first aspect of the invention, there is provided an electronic gaming machine comprising:

a display for displaying a game, wherein said game comprises game positions arranged into a plurality of reels and predetermined winning combinations of randomly selected game symbols in said game positions award prizes to a player; and

an electronic game controller for controlling the display of said game symbols on said display;

wherein the appearance of special game symbols in the game positions of at least a predetermined number of reels causes said electronic game controller to award a bonus prize, said bonus prize being dependent on the number of reels that display said special game symbols in each of their respective game positions.

Preferably, the value of said bonus prize increases as the number of said reels increases.

Preferably, said predetermined number of reels is one. Alternatively, said predetermined number of reels is two.

Preferably, said bonus prize is awarded for adjacent reels having special game symbols displayed in their respective game positions. More preferably, said adjacent reels comprise three reels, four reels or five reels.

Preferably, said bonus prize is awarded for three reels having special game symbols displayed in their respective game positions. More preferably, said three reels are adjacent each other.

Preferably, said bonus prize is awarded for four reels having special game symbols displayed in their respective game positions.

Preferably, said bonus prize is awarded for five reels having special game symbols displayed in their respective game positions.

Preferably, there are different types of said special game symbols. More preferably, said bonus prize increases in value where said predetermined number of reels have the same type of special game symbol displayed in their respective game positions.

In one embodiment, said bonus prize is awarded for at least three reels having the same type of special game symbol displayed in their respective game positions. In another embodiment, said bonus prize is awarded for at least four reels having the same type of special game symbol displayed in their respective game positions. In other embodiments, said bonus prize is awarded for at least five reels having the same type of special game symbol displayed in their respective game positions

In some embodiments, said special game symbols comprise differently coloured special game symbols.

Preferably, said bonus prize comprises a jackpot prize.

Preferably, there is a plurality of said bonus prizes.

Preferably, a trigger event causes said electronic game controller to respin one or more of said reels. More preferably, said trigger event comprises the appearance of said special game symbols in the game positions of said predetermined number of reels and said electronic game controller respins the other reels.

It is further preferred that the appearance of said special game symbols in the game positions of a respun reel causes said electronic game controller to award a game enhancing element upon said player. In one embodiment, the appearance of said special game symbols in the game positions of a respun reel causes said electronic game controller to respin the other respun reels. In another embodiment, said game enhancing element comprises awarding the player with a free play of said game.

Preferably, the appearance of said special game symbols in the game positions of one of said reels causes said electronic game controller to award a multiplier that increases the value of any prizes and/or bonus prizes awarded to said player. More preferably, the value of said multiplier depends on the type of said special game symbol. In some embodiments, different multiplier values are associated with the differently coloured special game symbols.

Preferably, an image corresponding to said multiplier is displayed adjacent to at least one of said special game symbols. More preferably, said multiplier image comprises a number that corresponds to the value of said multiplier. In some embodiments, said multiplier image is displayed only when said other reels or other respun reels are respun. In other embodiments, said multiplier image is displayed adjacent to each said special game symbol only when said special games symbols appear in the game positions of said one reel. In a further embodiment, said multiplier image is displayed adjacent to each special game symbol displayed in said array.

Preferably, said reels are arranged vertically within an array. Alternatively, said reels are arranged horizontally within an array.

Preferably, one or more of said game enhancing elements are awarded. Preferably, said one or more game enhancing elements modify the result of a play of said game. More preferably, said game enhancing elements comprise at least one or more of a predetermined number of free games, a win multiplier, wild multipliers, bonus wilds, symbols that cause the award of additional free games, trigger symbols to retrigger said at least two second arrays, held columns, random wild symbols, stacked symbols, bonus symbols, new game symbols, reveal symbols, progressives, bonus credits, jackpot symbols, and one or more symbol replacements.

Preferably, the game comprises a base game. Preferably, said game comprises a feature game. More preferably, there is both a base game and a feature game. In some embodiments, said special game position is available for play only in said base game, only in said feature game or in both said base game and said feature game.

Preferably, said electronic gaming machine comprises a base game and a feature game, wherein said base game and said feature game each comprises said array of reels, and said base game array is different in size and/or dimensions to said feature game array. More preferably, said feature game array is greater in size than said base game array. In one embodiment, said base array comprises three rows and five columns and said feature game array comprises either more than three rows or more than five columns. In a further embodiment, said feature game array is an extended base game array.

Preferably, a feature game trigger event occurs in said base game to trigger said feature game. In one embodiment, said feature game trigger event comprises a random event determined by said electronic game controller at the start of play of said feature game. In another embodiment, the feature game trigger event comprises the appearance of at least one trigger symbol in said base game array. In another alternative, the feature game trigger event comprises an in-game event during play of the base game.

Preferably, said array (including the base game array and/or the feature game array) takes any one of a circular, triangular, oval, semi-circular, hexagonal, pentagonal, octagonal, non-rectangular or polygonal shape.

Preferably, in response to a feature game trigger event in said base game, said electronic game controller causes said display to display game symbols for playing said feature game. Alternatively, said electronic game controller causes the display of said feature game and said base game during play of said base game, said feature game being inactive until triggered. In this embodiment, the change in said feature game from being inactive to active may be indicated on the display. This indication may be visual, aural or a combination of both.

Preferably, said player selectively starts and/or stops play of said reels in said game array and/or said reels in said feature game.

Preferably, said electronic gaming machine comprises a housing having said display and containing said electronic game controller.

Preferably, said electronic gaming machine comprises an input device. It is also preferred that said input device comprises one or more buttons on said housing, said buttons being in electronic communication with said electronic game controller to transmit player commands to said electronic game controller. More preferably, said buttons are arranged on a console of said housing. Alternatively or additionally, said input device comprises a touch sensitive surface on said display for receiving player commands, said touch sensitive surface being in electronic communication with said electronic game controller to transmit player commands to said electronic game controller.

Preferably, said electronic gaming machine comprises a value transfer mechanism for paying said prizes to said player using value in an amount equal to an awarded prize. Alternatively or additionally, said value transfer mechanism receives value from said player to make said bet and initiate play of a game on said electronic gaming machine. More preferably, said value transfer mechanism is in electronic communication with said electronic game controller. It is also preferred that said value transfer mechanism is provided on said housing. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means money denominations, credits, gaming tokens, coins, paper, currency, tickets, vouchers (both physical and electronic), credit cards, debit cards, smart cards, memory devices capable of storing value and any other object representative of value.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

A second aspect of the present invention provides an electronic gaming machine comprising:

a display for displaying game symbols for playing a game, said game comprising game positions arranged into a plurality of reels and predetermined winning combinations of randomly selected game symbols in said game positions award prizes to a player;

an electronic game controller for controlling the display of said game symbols on the display; and

a value transfer mechanism for receiving value from a player to make a bet and initiate play of said game on said display;

wherein said electronic game controller in response to said player making a bet via said value transfer mechanism commences play of said game by randomly selecting game symbols and causing said display to display said randomly selected game symbols; and

wherein the appearance of special game symbols in the game positions of at least a predetermined number of reels causes said electronic game controller to award a bonus prize, said bonus prize being dependent on the number of reels that display said special game symbols in each of their respective game positions.

This second aspect of the invention preferably has the preferred features of the first aspect of the invention stated above, where applicable.

According to a third aspect of the invention, there is provided a gaming method for an electronic gaming machine comprising a display and an electronic game controller, comprising:

controllably displaying game symbols on said display to play a game;

arranging wherein game positions into a plurality of reels, wherein predetermined winning combinations of randomly selected game symbols in said game positions award prizes to a player; and

in response to the appearance of special game symbols in the game positions of at least a predetermined number of reels, awarding a bonus prize dependent on the number of reels that display said special game symbols in each of their respective game positions.

Preferably, said method comprises increasing the value of said bonus prize as the number of said reels increases.

Preferably, said method comprises setting said predetermined number of reels as one. Alternatively, said method comprises setting said predetermined number of reels as two.

Preferably, said method comprises awarding said bonus prize for adjacent reels having special game symbols displayed in their respective game positions. More preferably, said method comprises awarding said bonus prize for three, four or five adjacent reels.

Preferably, said method comprises awarding said bonus prize for three reels having special game symbols displayed in their respective game positions.

Preferably, said method comprises awarding said bonus prize four reels having special game symbols displayed in their respective game positions.

Preferably, said method comprises awarding said bonus prize for five reels having special game symbols displayed in their respective game positions.

Preferably, said method comprises providing different types of said special game symbols. More preferably, said method comprises increasing the value of said bonus prize where said predetermined number of reels have the same type of special game symbol displayed in their respective game positions.

In one embodiment, said method comprises awarding said bonus prize for at least three reels having the same type of special game symbol displayed in their respective game positions. In another embodiment, said method comprises awarding said bonus prize for at least four reels having the same type of special game symbol displayed in their respective game positions. In other embodiments, said method comprises awarding said bonus prize for at least five reels having the same type of special game symbol displayed in their respective game positions.

In some embodiments, said method comprises providing differently coloured special game symbols.

Preferably, said method comprises awarding a jackpot prize as said bonus prize said bonus prize.

Preferably, said method comprises providing a plurality of said bonus prizes.

Preferably, said method comprises providing a trigger event and causing said electronic game controller to respin one or more of said reels in response to said trigger event. More preferably, said method comprises providing as said trigger event the appearance of said special game symbols in the game positions of said predetermined number of reels and causing said electronic game controller to respin the other reels.

It is further preferred that said method comprises causing said electronic game controller, in response to the appearance of said special game symbols in the game positions of a respun reel, to award a game enhancing element upon said player. In one embodiment, said method comprises causing said electronic game controller, in response to the appearance of said special game symbols in the game positions of a respun reel, to respin the other respun reels. In another embodiment, said method comprises providing the player with a free play of said game as said game enhancing element.

Preferably, said method comprises arranging said reels vertically within an array. Alternatively, said method comprises arranging said reels horizontally within an array.

The method of the third aspect of the invention preferably has any other preferred features of the first aspect of the invention where applicable.

A fourth aspect of the present invention provides a gaming method for an electronic gaming machine comprising a display for displaying a game, wherein said game comprises displaying randomly selected game symbols and the display of predetermined winning combinations of said game symbols results in the award of prizes to a player; an electronic game controller for controlling the display of said game symbols for playing said game on said display; and a value transfer mechanism for receiving value from a player to make a bet and initiate play of said game, the method comprising:

said value transfer mechanism receiving value from a player to initiate play of said game on said display;

said electronic game controller arranging said game symbols into an array of predetermined game positions;

said electronic game controller designating at least one of said predetermined game positions as a special game position in said array, wherein said game symbols are displayable in said special game position;

said electronic game controller associating two or more game positions with said special game position; and

in response to the appearance of a special game symbol appearing in said special game position in a play of said game, said electronic game controller awarding a prize for each associated game position, said prizes being based on the game symbols displayed in said associated game positions.

The method of the fourth aspect of the invention preferably has the preferred features of the third aspect of the invention stated above, where applicable.

According to a fifth aspect of the invention, there is provided a gaming system comprising a central processing unit configured for communication with an electronic gaming machine, wherein said gaming system is configured to perform the method of the third or fourth aspects of the invention on said electronic gaming machine.

According to a sixth aspect of the invention, there is provided a computer programme configured to perform the method of the third or fourth aspects of the invention.

According to a seventh aspect of the invention, there is provided a non-transitory carrier medium carrying computer executable code that, when executed on a central processing unit configured for communication with an electronic gaming machine, causes the central processing unit to perform the method of the third or fourth aspects of the invention on said electronic gaming machine.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a schematic drawing of an electronic game controller for the electronic gaming machine of FIG. 1;

FIG. 3 is a simulated screen shot of a base game played on the electronic gaming machine of FIG. 1;

FIG. 4 is a simulated screen shot illustrating a feature game played on the electronic gaming machine of FIG. 1;

FIGS. 5 to 14 are simulate screen shots illustrating the feature game of FIG. 4;

FIG. 15 is a schematic drawing illustrating another embodiment of the invention;

FIGS. 16A to 16C are schematic drawings illustrating a further embodiment of the invention;

FIGS. 17A and 17B are schematic drawings illustrating yet another embodiment of the invention;

FIG. 18 is a perspective view of an electronic gaming machine according to yet another embodiment of the invention;

FIG. 19 is a schematic drawing of a control panel for the electronic gaming machine of FIG. 18; and

FIG. 20 is a block diagram of the electronic components of the electronic gaming machine of FIG. 18.

### DETAILED DESCRIPTION OF VARIOUS EMBODIMENTS

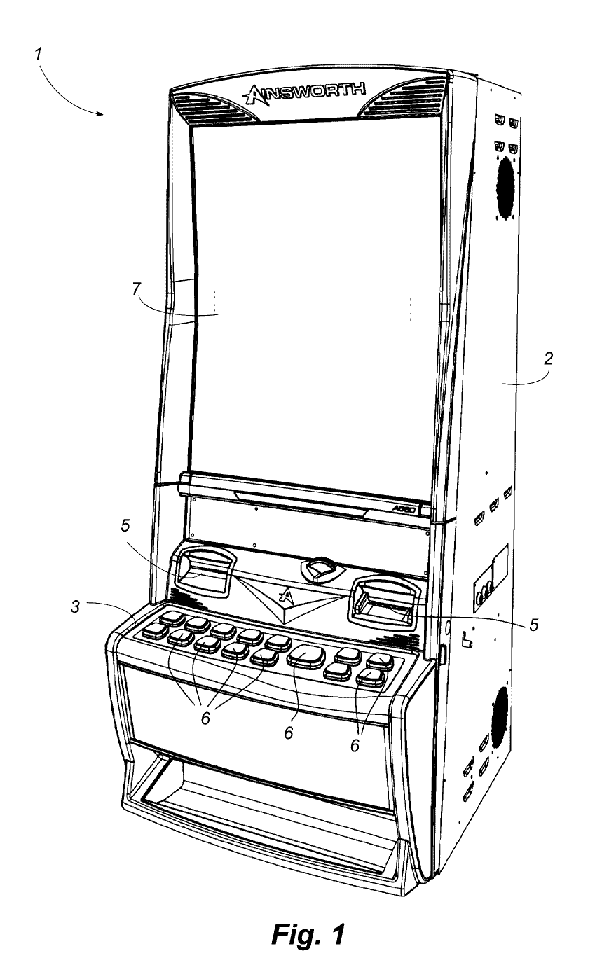

The present invention will now be described with reference to the following examples which should be considered in all respects as illustrative and non-restrictive. In the Figures, corresponding features within the same embodiment or common to different embodiments have been given the same reference numerals. Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

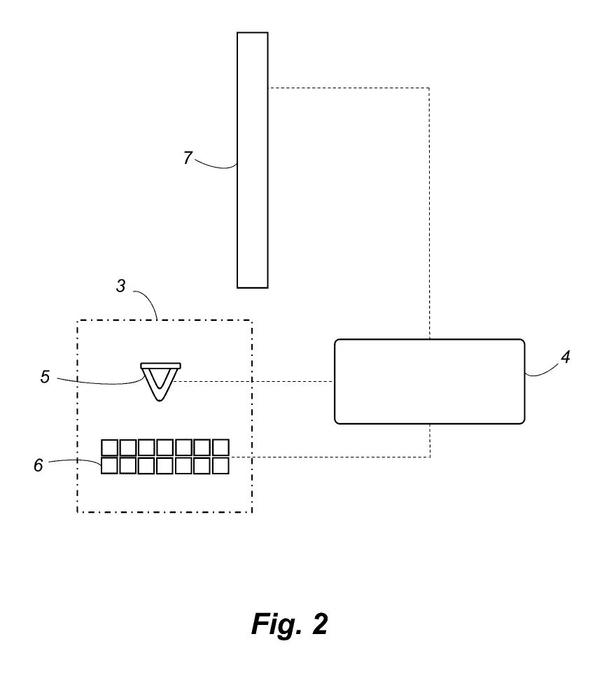

The electronic game controller 4 is generally in the form of a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store programme instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine 1.

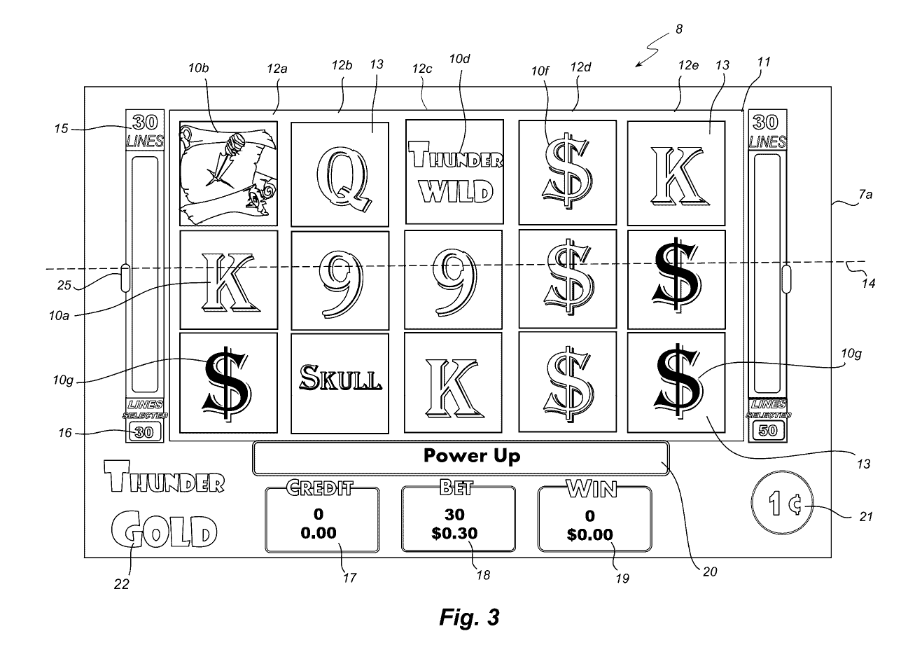

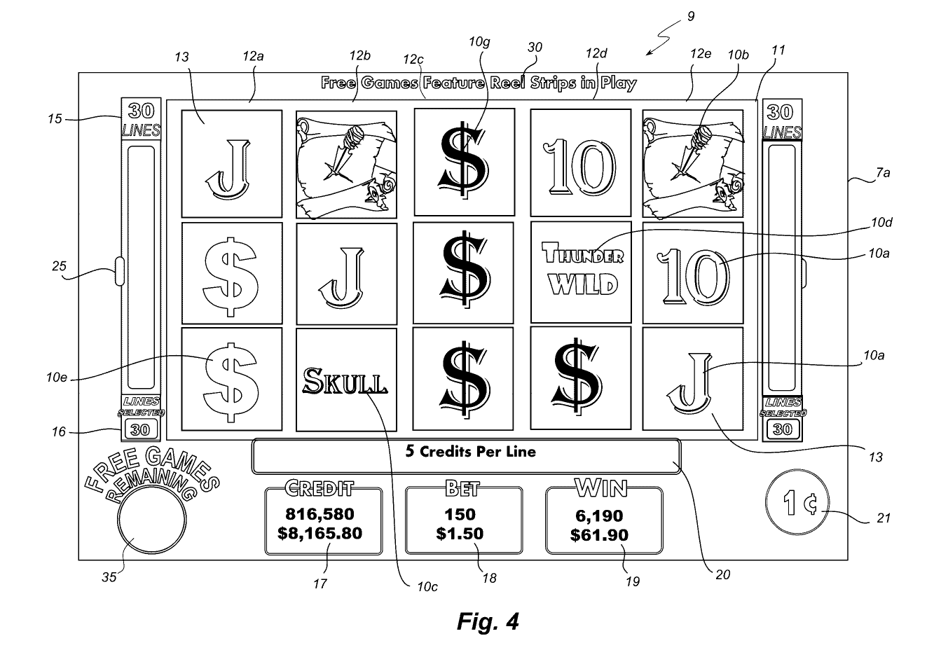

The electronic game controller 4 is programmed to provide a game in the form of a base game 8 (as best shown in FIG. 3) and a feature game 9 (as best shown in FIG. 4) on a lower display area 7a of the display 7 of the electronic gaming machine 1 for play by a player. The base game 8 has game symbols 10 arranged into an array 11 in the form of five columns or “reels” 12a, 12b, 12c, 12d and 12e. The reels 12a, 12b, 12c, 12d and 12e give the visual appearance of rotating, typically by having the game symbols 10 move in a downward linear path along the length of each reel 12a, 12b, 12c, 12d and 12e. The array 11 is arranged with five reels 12a, 12b, 12c, 12d and 12e and three rows as per the industry standard, it will be appreciated by one skilled in the art that other types of arrays could be used, such as 3x3, 4x3, 5x5, 4x4, etc, including arrays having an irregular number of rows and/or columns. For example, the array 11 can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game 8 and feature game 9 to be played on the lower display area 7a, including showing the game symbols 10, array 11 and other visible elements of the games.

The array 11 of the base game 8 defines predetermined symbol positions 13, in which the game symbols 10 appear. In this embodiment, the symbol positions 13 are not defined by any visible boundary lines and simply provide an area for the game symbols 10 to appear. However, it will be appreciated that in other embodiments, the symbol positions 13 are visually marked by boundary lines to define “squares” or “cells”. In yet other embodiments, other markings can be used to define each respective area of the symbol positions 13 or game positions.

The array 11 is arranged so that a player can select one or more predetermined “pay lines” 14 defined around the array, which correspond to combinations of the symbol or game positions 13. The pay lines 14 correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event (like activating a feature game) or confers an award, where the trigger symbol may or may not have to appear in combination and may or may not have to appear on the same player-selected pay line 14. In this embodiment, the game symbols 10 include playing card symbols 10a, picture symbols 10b, a scatter symbol 10c in the form of a “Skull” symbol and a substitute or wild card symbol in the form of a “Thunder Wild” symbol 10d. The Skull symbol 10c also acts as a trigger symbol to trigger the feature game 9. In this embodiment, there are additional trigger symbols in the form of a red dollar symbol 10e, green dollar symbol 10f and a blue dollar symbol 10g that trigger the award of a bonus prize, which will be referred hereinafter as “bonus symbols”. The electronic game controller 4 randomly determines the appearance of the game symbols 10 on the array 11.

The lower display area 7a also displays other standard game information including the number of pay lines 15, the number of pay lines selected 16, the amount of player credits 17, the amount of the current bet wagered by the player 18, the amount of wins by the player 19, a message area 20, a current denomination button 21 indicating the currently selected base bet denomination and the name of the game 22 “Thunder Gold”™. Other standard information may also include a menu button (not shown) for bringing up a menu screen (not shown).

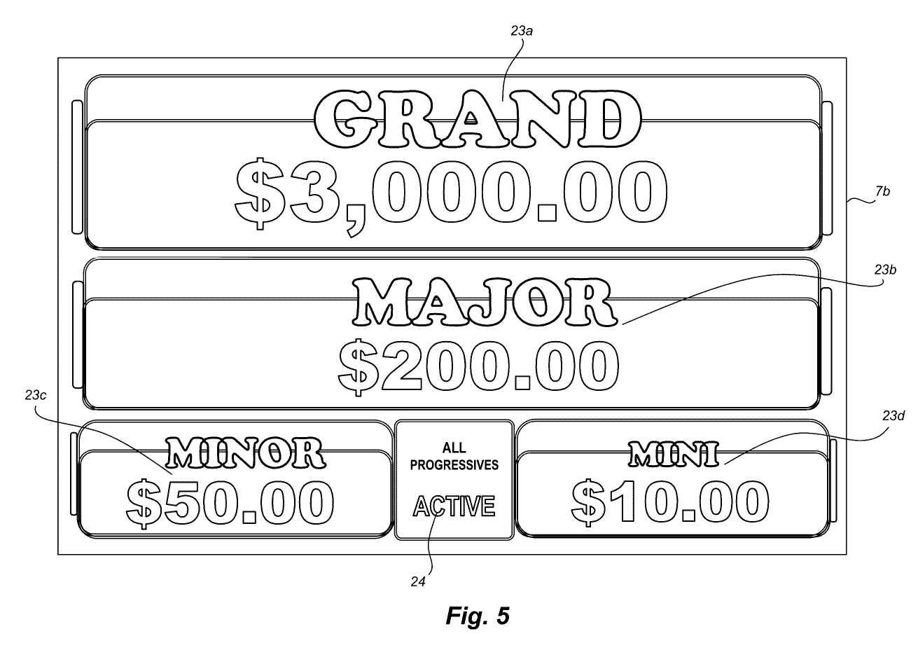

An upper display area 7b of the video screen 7 may display an animated title or feature screen for the game and/or information relating to the rules for the base game 8 and feature game 9 discussed below. This includes information outlining the key characteristics of the base game 8 and feature game 9. In this embodiment, the upper display area 7b also displays jackpot information relating to the feature game 9 that is awarded by the electronic gaming machine 1, as best shown in FIG. 5. This jackpot information in this embodiment comprises, in descending order of monetary value, a grand jackpot 23a, major jackpot 23b, minor jackpot 23c and mini jackpot 23d. A message box 24 advises that the jackpots 23 are available to be won by the player during the feature game 9.

The player initially makes a bet using vending slots 5 initiate play of the electronic gaming machine 1 to build up credit to play the base game 8 on the electronic gaming machine. For example, the player can bet or wager monetary amounts equivalent to a particular amount of credits, depending on the bet denomination selected for the base game. Also, the player can make any additional side bets or ante-bets during play of the base game 8 once the game has commenced to access additional features in the game, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc. Usually, the bet option selected determines the number of pay lines 14 that become payable in the base game 8 and/or feature game 9.

The electronic gaming machine also typically has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Typically, the electronic game controller 4 will select the bet denomination with the lowest value that is available for the base game 8, which would be the 1¢ bet denomination for this embodiment. The player may change the bet denomination at any time in the base game 8 by touching the denomination button before or after the reels 12 have spun. In this embodiment, touching the denomination button 21 will bring denomination images (including from 1¢, 2¢, 5¢ 10¢, 20¢, 50¢ and up to $1) that the player may select to quickly change the bet denomination between plays of the base game 8.

Once the player has made a bet to commence play of the game 8, the electronic game controller 4 then transmits a signal to the display 7 to make reels 12 to appear to visibly rotate or “spin” in a linear path, typically in a downward vertical direction, and randomly display the game symbols 10 in each symbol position 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10. Where playing card symbols are optionally used, other predetermined winning combinations include poker-based combinations of a “full house”, “straight” or “flush”. It will be appreciated that other winning combinations of game symbols 10 can also be provided. If so, the electronic gaming machine 1 enters a winning game state and awards a prize according to the displayed predetermined winning combination.

In addition, the electronic game controller 4 randomly determines whether a predetermined trigger event has occurred which triggers the feature game 9 on the electronic gaming machine 1. In this embodiment, the trigger event is the appearance of three Skull symbols 10c anywhere on the reels 12 without having to be on a player-selected pay line 14. In response to this trigger event, the electronic game controller 4 then causes the feature game 9 to be shown on the lower display area 7a of the screen 7, as best shown in FIG. 4. The jackpot and other game information remains shown in the upper display area 7b. However, it will be appreciated that in other embodiments, the feature game 9 can be shown to occupy the entire screen 7 or in the upper display area 7b. Where the feature game 9 occupies the entire screen, it may use an enlarged array that has substantially more symbol positions 13 than the array 11 in the base game 8.

The feature game 9 uses the same array 11, same game symbols 10, reels 12a to 12e, symbol positions 13 and pay lines 14 from the base game 8. A message 30 appears at the top of the array 11 advising the player that the reels 12 are using enhanced reel strips that increase the probability of higher value game symbols (such as substitute Thunder Wild symbols 10d or the bonus symbols 10e to 10g) and thus the probability of obtaining winning combinations and/or winning combinations of higher value. In the feature game 9, eight free plays or spins of the reels 12 are awarded to the player. It will be understood by those skilled in the art that a free spin involves a play of the game without requiring any bet to be made by the player, and that any number of free spins can be chosen for the feature game. In addition, it will be appreciated that in the art free spins are commonly referred to as “free games”. The number of free spins left in the feature game 9 is indicated in a counter 35, as best shown in FIG. 4.

The feature game 9 operates in a similar manner to the base game 8, where the reels 12 visibly rotate and display randomly selected game symbols 10 in each game position 13, as best shown in FIG. 4. Predetermined winning combinations of randomly selected game symbols 10 in the array 11 of the feature game 9 also result in the award of prizes to the player, usually of an enhanced value compared to the prizes awarded in the base game 8.

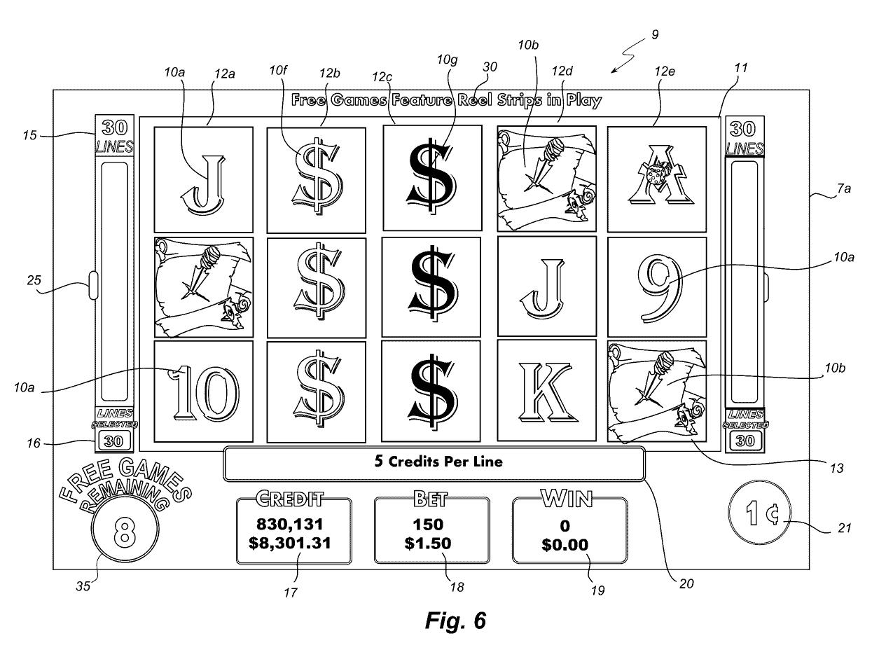

Referring to FIG. 6, a free spin in the feature game 9 results in the appearance of the green bonus symbols 10f in each game position 13 of reel 12b and the blue bonus symbols 10g in each game position 13 of reel 12c is a trigger event that causes the electronic game controller 4 to respin the remaining reels 12a, 12d and 12e that do not display the bonus symbols 10e to 10g in each of their respective game positions 13. A single bonus symbol 10e to 10g in a reel 12 will not contribute to the trigger event. In this embodiment, the trigger event requires bonus symbols 10e, 10f or 10g to appear in each game position 13 of any two of the reels 12a to 12e, and the same bonus symbols 10e to 10g to appear in the same reel 12. That is, the same bonus symbol 10e to 10g must appear in each game position 13 of a reel 12, which is generally known as a “stack”, “stacked symbols” or a “symbol stack”, to trigger the respin. A mixture of different bonus symbols 10e to 10g in the same reel 12 will not trigger the respin of the remaining reels 12a, 12d and 12e. It will be appreciated that in some embodiments, a mixture of different bonus symbols 10e to 10g in the same reel 12 is sufficient to trigger the respin of the remaining reels 12a, 12d and 12e. In other embodiments, the same bonus symbol 10e to 10g must appear in each game position 13 of both reels 12. In further embodiments, a mixture of the bonus symbols or same bonus symbol 10e to 10g can appear in only one reel to trigger the respin of the remaining reels 12a, 12d and 12e.

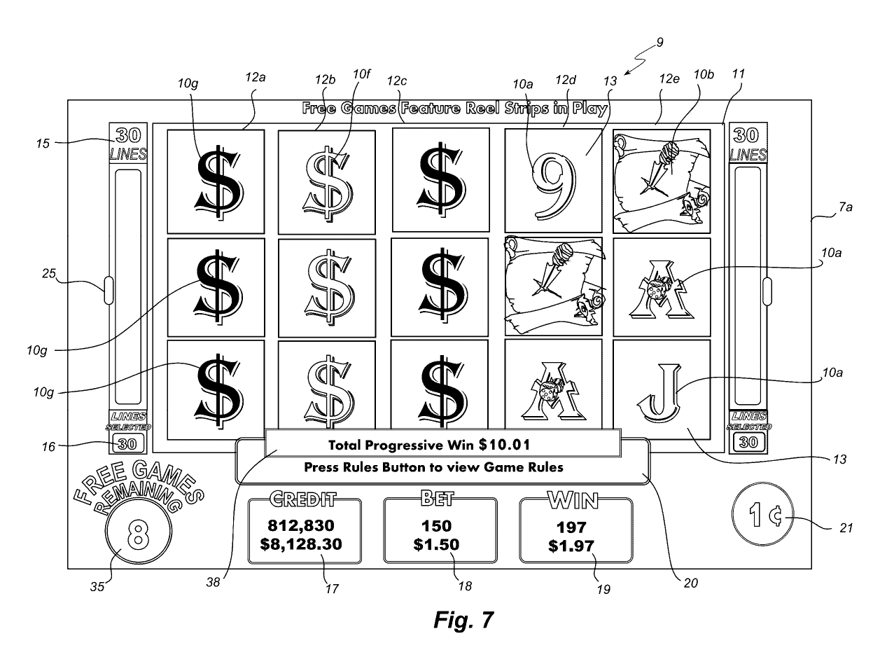

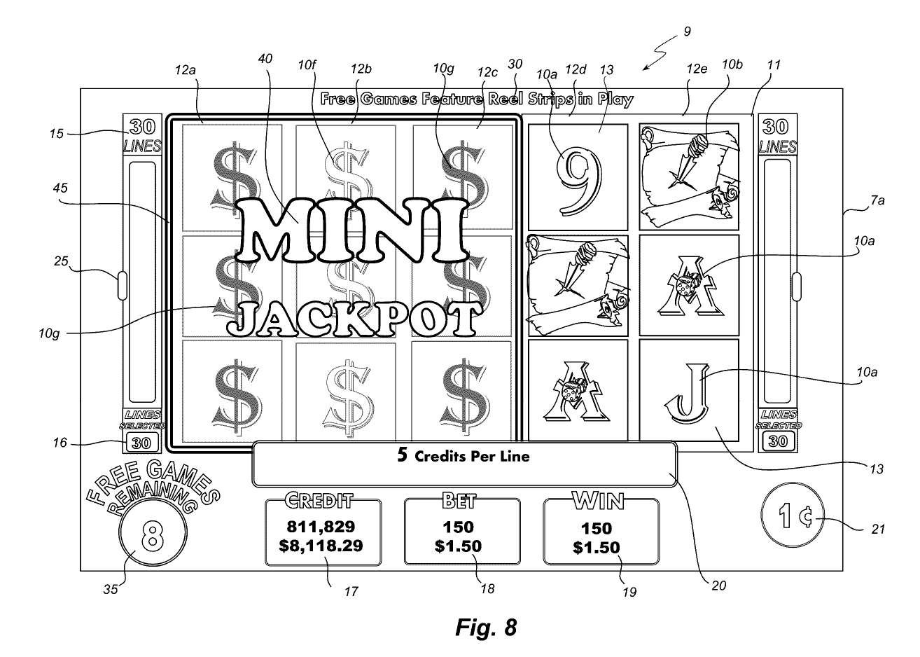

FIG. 7 shows the result of the respin of the remaining reels 12a, 12d and 12e triggered by the stacked bonus symbols 10f, 10g in reels 12b and 12d in FIG. 6. As indicated by the counter 35, the respin of the reels 12a, 12d and 12e did not count against the eight free spins initially awarded upon triggering the feature game 9. The respin of reels 12a, 12d and 12e has resulted in the appearance of the blue bonus symbols 10g in each game position 13 of the reel 12a, thus causing three reels 12a to 12c having stacked bonus symbols 10f, 10g. This combination of stacked bonus symbols 10f, 10g in three of the reels 12a to 12e causes the electronic game controller 4 to award a bonus prize in the form of one of the jackpots 23 to the player. A message 38 appears above the message area 20 to advise the player that a progressive win (being, the mini jackpot 23d) has been won. The lower display area 7a changes to the screen as shown in FIG. 8, where a text message MINI JACKPOT 40 appears in a bonus prize image 45 superimposed over the reels 12a to 12c that triggered the award of the mini jackpot 23d. The bonus prize image 45 is partly transparent so that the underlying stacked bonus symbols 10f, 10g in the reels 12a to 12c can still be seen by the player. After the mini jackpot 23d is awarded to the player, the feature game 9 continues with the respin of the remaining reels 12d, 12e.

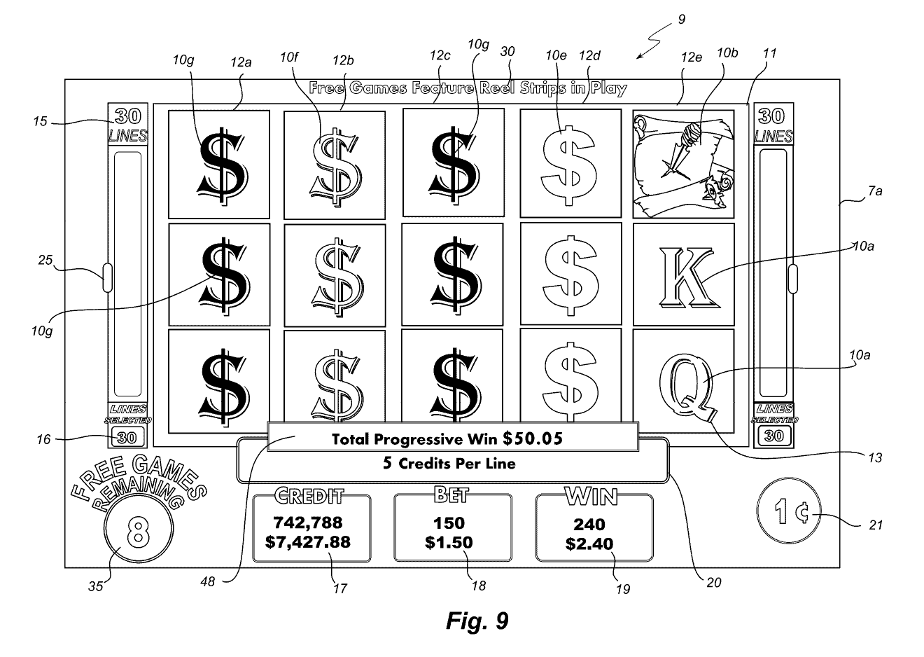

In addition to the award of the mini jackpot 23d, the appearance of another stack of blue bonus symbols 10g in reel 12a also triggers a further respin of the remaining reels 12d, 12e that do not display stacked bonus symbols 10e to 10g. This respin is triggered by any new stack of bonus symbols 10e, 10f or 10g that appear on the reels 12a to 12e. The result of the respin of reels 12d, 12e is shown in FIG. 9. Again, this additional respin of the reels 12d, 12e does not count against the initially awarded free spins for the feature game 9. Hence, as shown in FIG. 9, the counter 35 still shows that eight free spins are remaining.

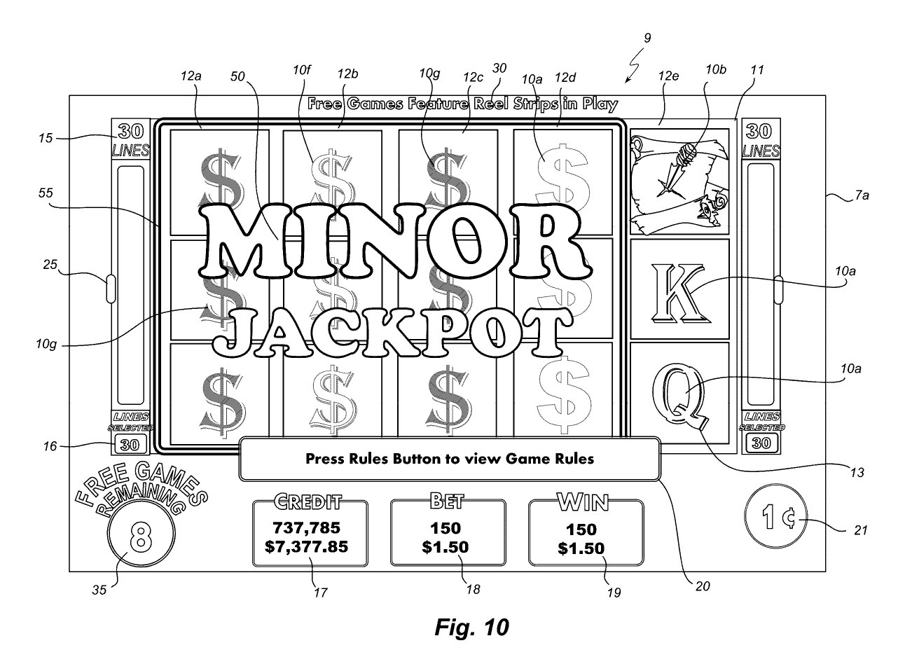

In FIG. 9, a stack of red bonus symbols 10e has appeared in reel 12d, triggering both the award of a jackpot 23 and a further respin of last remaining reel 12e that does not have stacked bonus symbols 10e to 10g. The combination of stacked bonus symbols 10e, 10f and 10g in four reels, being 12a to 12d, causes the electronic game controller 4 to award the minor jackpot 23c to the player. A message 48 appears above the message area 20 to advise the player that a progressive win (being, the minor jackpot 23c) has been won. As best shown in FIG. 10, the array 11 then displays a text message MINOR JACKPOT 50 appears in a bonus prize image 55 superimposed over the reels 12a to 12d that triggered the award of the minor jackpot 23c. As before, the bonus prize image 55 is partly transparent so that the underlying stacked bonus symbols 10e, 10f and 10g in the reels 12a to 12d can still be seen by the player. After the minor jackpot 23c is awarded to the player, the feature game 9 continues with the respin of the last remaining reel.

The respinning of reels that do not show stacked bonus symbols 10e to 10g continues each time a new stack of bonus symbols 10e to 10g appears on the reels 12 until either all the reels 12a to 12e show stacked bonus symbols or there are no stacked bonus symbols displayed on remaining reels as a result of the respin. In the either case, the feature game 9 resumes with the next free spin.

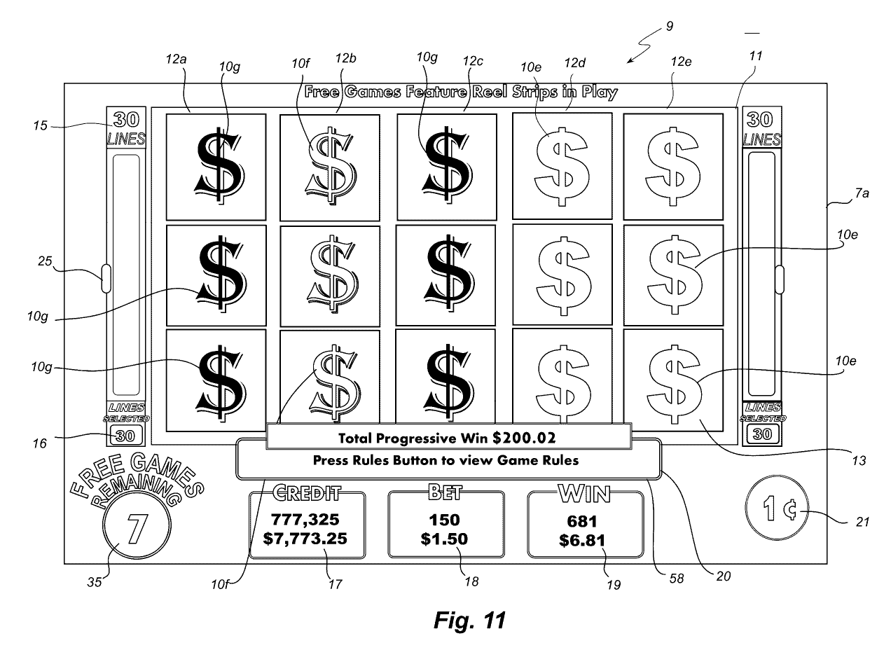

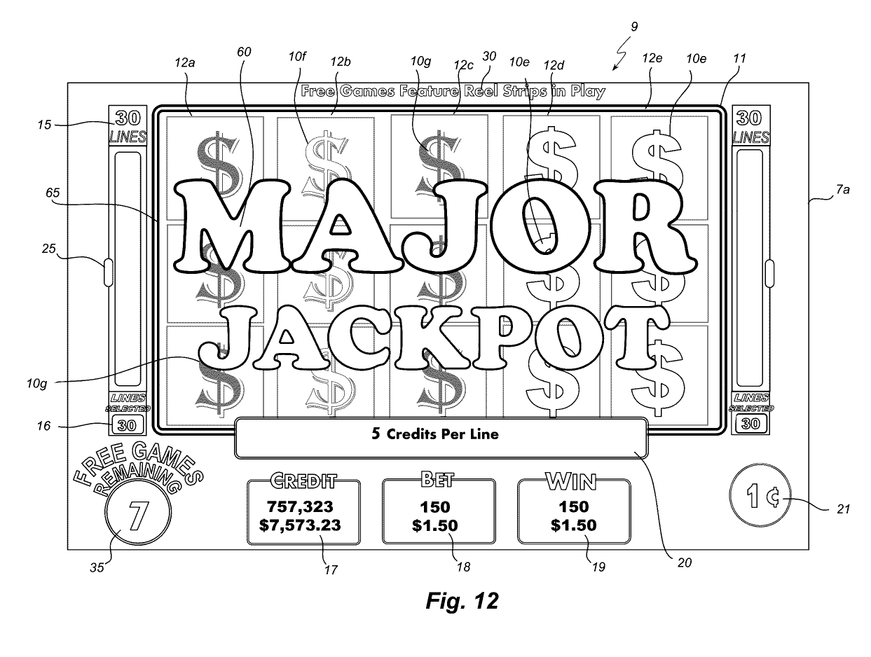

The next free spin of the feature game 9 again results in stacked bonus symbols 10e to 10g appearing in two of the reels 12a to 12e, resulting in a respin of the remaining three reels. The result of this respin is shown in FIG. 11, and bonus symbols have appeared in stacks in each reel 12a to 12e, two stacks of the red bonus symbols 10e have appeared in reels 12d, 12e, one stack of the green bonus symbols 10f in the reel 12b and two stacks of the blue bonus symbols 10g in the reels 12a, 12c. As all the reels 12a to 12e show stacked bonus symbols 10e to 10g, there is no need to respin any of the reels. A message 58 advises the player that one of the jackpots 23 has been won and the array 11 then displays a text message MAJOR JACKPOT 60 appears in a bonus prize image 65 superimposed over the reels 12a to 12e that triggered the award of the major jackpot 23b, as best shown in FIG. 12. As before, the bonus prize image 65 is partly transparent so that the underlying stacked bonus symbols 10e, 10f and 10g in the reels 12a to 12e can still be seen by the player. In both Figures, the counter 35 shows that seven free spins remain in the feature game 9. After the major jackpot 23b is awarded to the player, the feature game 9 resumes with the next free spin.

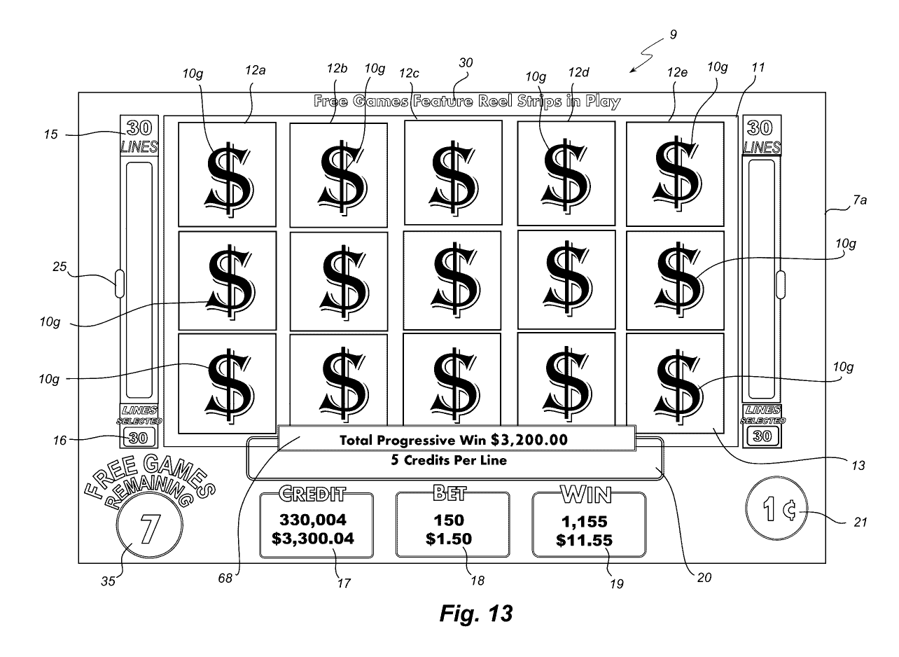

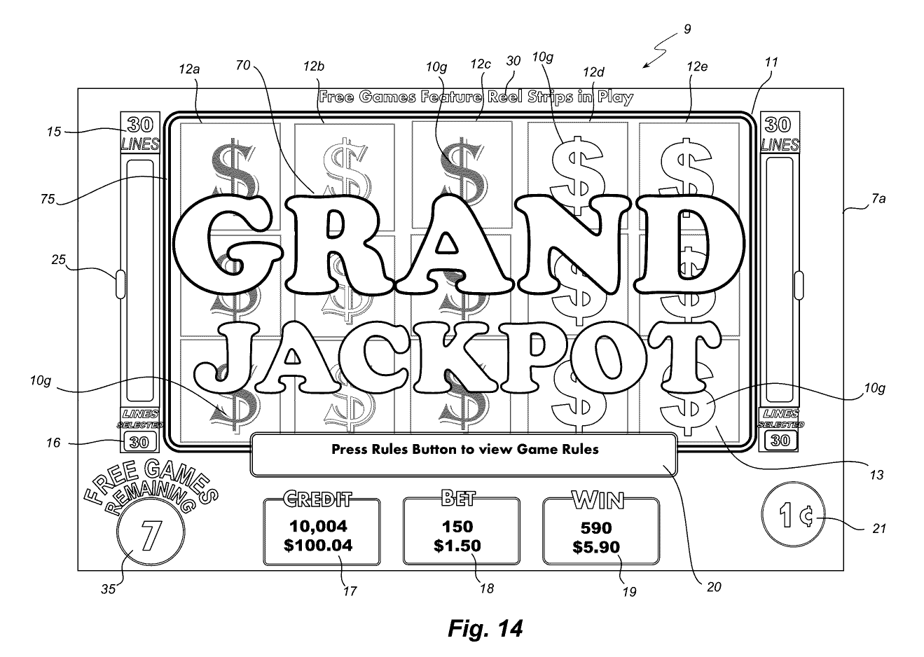

FIG. 13 shows the result of a respin of the remaining three reels after stacked bonus symbols 10e to 10g have appeared in two of the reels 12a to 12e. In this case, stacked blue bonus symbols 10g have appeared in each of the reels 12a to 12e. Since the same type of bonus symbol (being the blue bonus symbol 10g) has appeared in each of the game positions 13 of all the reels 12a to 12e, the player is awarded the highest jackpot 23 offered on the electronic gaming machine 1, being the grand jackpot 23a. A message 68 advises the player of the amount of the grand jackpot 23a that has been won and the array transitions to display a text message GRAND JACKPOT 70 appears in a bonus prize image 75 superimposed over the reels 12a to 12e that triggered the award of the grand jackpot 23a, as best shown in FIG. 14. As in the other Figures, the bonus prize image 75 is partly transparent so that the underlying stacked bonus symbols 10g in the reels 12a to 12e can still be seen by the player. After the grand jackpot 23a is awarded to the player, the feature game 9 resumes with the next free spin.

It should be noted that in the embodiment, there are bet restrictions as to the award of the jackpots 23a to 23d. In this case, the max bet option for the base bet denomination must be selected by the player to have the grand, major, minor and mini jackpots 23a to 23d available to be won in the feature game 9. Where less than the max bet option is selected by the player, a bonus prize is awarded that is less than their corresponding jackpot 23. For example, instead of awarding the mini jackpot 23d, a mini bonus is awarded for bonus symbols 10e to 10g appearing in stacks on three of the reels 12a to 12e. Likewise, the major and minor jackpots 23b and 23c is replaced by major and minor bonuses, respectively. In the case of the grand jackpot 23a, there is no corresponding grand bonus and instead the major bonus is awarded for the same type of bonus symbol appearing in stacks in all the reels 12a to 12e.

In some embodiments, there is no bet restriction on the availability of the jackpots 23a to 23d. In other embodiments, the jackpots 23a to 23d are awarded only for “pure” bonus symbol stacks; i.e. stacks of the same bonus symbol 10e, 10f or 10g, must appear in the relevant number of reels 12 to award the jackpots 23a to 23d. In this case, the major, minor and mini bonuses (as well as a grand bonus) are awarded for “mixed” bonus symbol stacks; i.e. the relevant number of reels 12 can have one reel with at stack of red bonus symbols 10e while another reel has a stack of blue bonus symbols 10g.

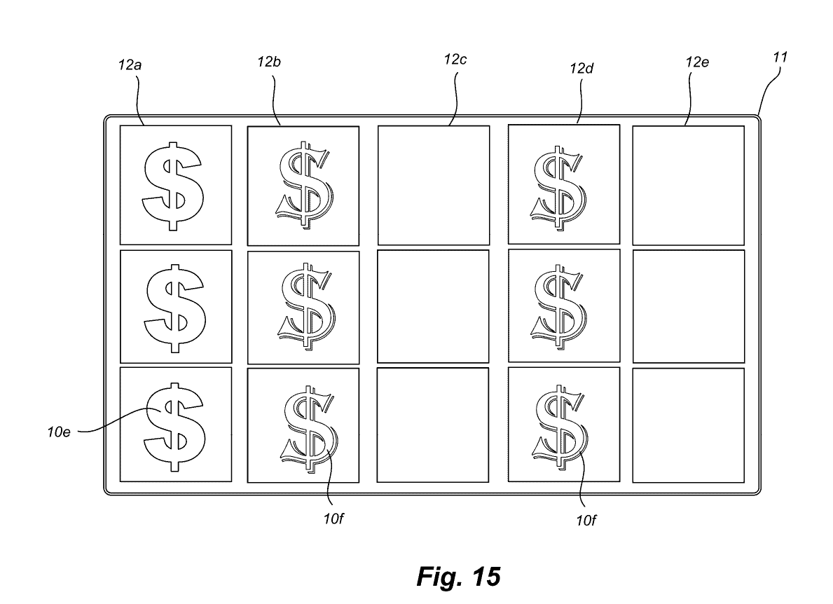

Furthermore, in the embodiment the stacked bonus symbols 10e to 10g must appear in adjacent reels starting from the leftmost reel 12a after the respin to form the groups of three and four reels of stacked bonus symbols that awards the mini and minor jackpots 23d, 23c. That is, reels 12a to 12c must display stacked bonus symbols 10e, 10f or 10g to cause the award of the mini jackpot 23d while reels 12a to 12d must display stacked bonus symbols 10e, 10f or 10g to result in the award of the minor jackpot 23c. In another embodiment, the stacked bonus symbols 10e to 10g must appear in adjacent reels starting from the rightmost reel 12e after the respin. In other embodiments, the stacked bonus symbols 10e, 10f or 10g can appear in any set of adjacent reels after the respin, such as reels 12b to 12d or 12c to 12e for the mini jackpot 23d or reels 12b to 12e for the minor jackpot 23c. In further embodiments, the stacked bonus symbols 10e, 10f or 10g need not appear in adjacent reels but can be any set of three or four reels 12, as best shown by way of example in FIG. 15, where reels 12b and 12d display the same (red) stacked bonus symbols 10e while reel 12a displays a stack of green bonus symbols 10f. In this case, the text messages 40, 50, 60, 70 and bonus prize images 45, 55, 65, 75 may appear across the array 11 or in a separate field or area adjacent the reels 12 or the array.

In the embodiment, the bonus symbols 10e to 10g have been distinguished from each other by using different colours and slightly different images for the dollar sign for each type of bonus symbol. It will be appreciated that in some embodiments, the different types of bonus symbols 10e to 10g are distinguished by colour alone or by using different images. In other embodiments, there is only one bonus symbol used to trigger the respins of the remaining reels 12 that do not display stacked bonus symbols and award of the jackpots 23a to 23d.

In the embodiment, the bonus symbols 10e to 10g can be animated to visually indicate and highlight their appearance to the player. For example, bonus symbols 10e to 10g may be static in game positions 13 when appearing along or in a group of two on the same reel 12, but when they appear in a stack on the reels 12a to 12e, the bonus symbols 10e to 10g become animated.

In other embodiments, the frequency (and thus appearance) of the bonus symbols 10e to 10g may depend on the bet option selected by the player. For example, selecting a max bet option makes the bonus symbols 10e to 10g have a higher frequency of appearing on the reels 12a to 12e during play of the feature game 9, in order to increase the chance of triggering the respin of the reels 12 compared to a bet option of less value.

In further embodiments, there is no need to provide a specific trigger event of two reels displayed stacked bonus symbols 10e to 10g for the respin of the other reels 12. Instead, the appearance a single reel 12 with stacked bonus symbols 10e, 10f or 10g is sufficient to commence a respin of the remaining reels 12.

Also, in some embodiments, there is a plurality of bonus prizes that can be won and not just a single bonus prize for each group of three, four or five reels 12 with stacked bonus symbols 10e to 10g.

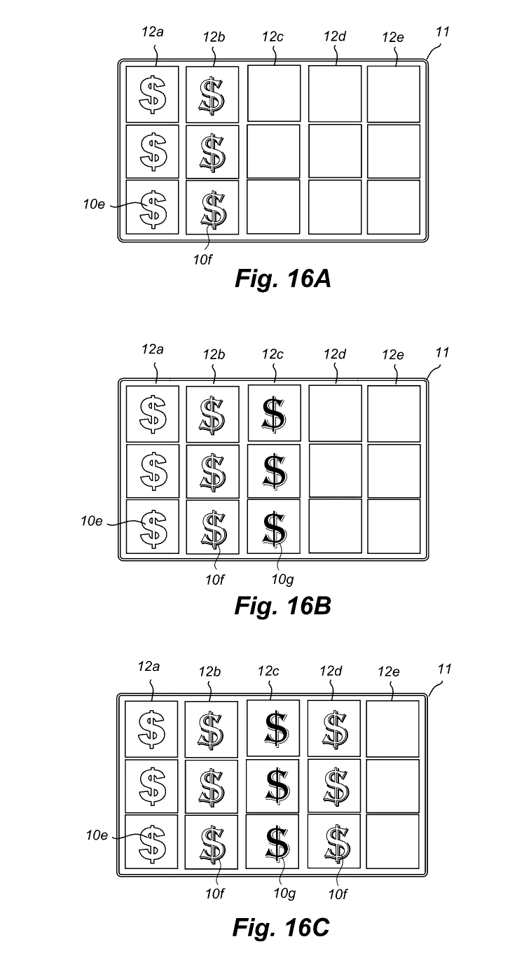

In a further embodiment illustrated in FIGS. 16A to 16D, the number of reels 12a to 12e with stacked bonus symbols 10e to 10g also confers the award of a multiplier in addition to the jackpot 23a to 23d and/or any prizes awarded for winning combinations of game symbols 10 on player-selected pay lines 14. For example, a reel 12 having a stack of red bonus symbols 10e may confer an ×1 multiplier, a reel 12 having a stack of green bonus symbols 10f may confer an ×2 multiplier and a reel 12 having a stack of blue bonus symbols 10g may confer an ×3 multiplier. These multipliers in turn “stack” or add together to provide a total multiplier that increases the amount awarded by the jackpots 23 and/or prizes for winning combinations appearing on the player-selected pay lines 14. For example, a free spin of the feature game 9 may occur where no stacked bonus symbols 10e to 10g appear in any of the reels 12a to 12e. FIG. 16A shows the next free spin of the feature game 9, where the reel 12a shows a stack of the red bonus symbols 10e and the reel 12b shows a stack of green bonus symbols 10f. This results in an award of an ×3 multiplier (×1 for the stacked red bonus symbols 10e and ×2 for the stacked green bonus symbols 10f) for any winning combinations of game symbols 10 appearing on player-selected pay lines 14. Since the appearance of two reels 12 with stacked bonus symbols 10e to 10g has appeared, this triggers the respin of the remaining reels 12c to 12e. The respin is shown in FIG. 16B, where reel 12c now shows a stack of blue bonus symbols 10g. This results in the award of an ×6 multiplier (×1 for the stacked red bonus symbols 10e, ×2 for the stacked green bonus symbols 10f and ×3 for the stacked blue bonus symbols 10g) for any winning combinations of game symbols 10 appearing on player-selected pay lines 14 and the mini jackpot 23d awarded for having three reels with stacked bonus symbols. The appearance of reel 12c with stacked bonus symbols 10g results in a further respin of the remaining reels 12d and 12e. This respin is shown in FIG. 16D, where reel 12d now shows a stack of green bonus symbols 10f. This results in the award of an ×8 multiplier (×1 for the stacked red bonus symbols 10e, ×4 for the two stacked green bonus symbols 10f each conferring an ×2 multiplier and ×3 for the stacked blue bonus symbols 10g) for any winning combinations of game symbols 10 appearing on player-selected pay lines 14 and the midi jackpot 23c awarded for having four reels with stacked bonus symbols.

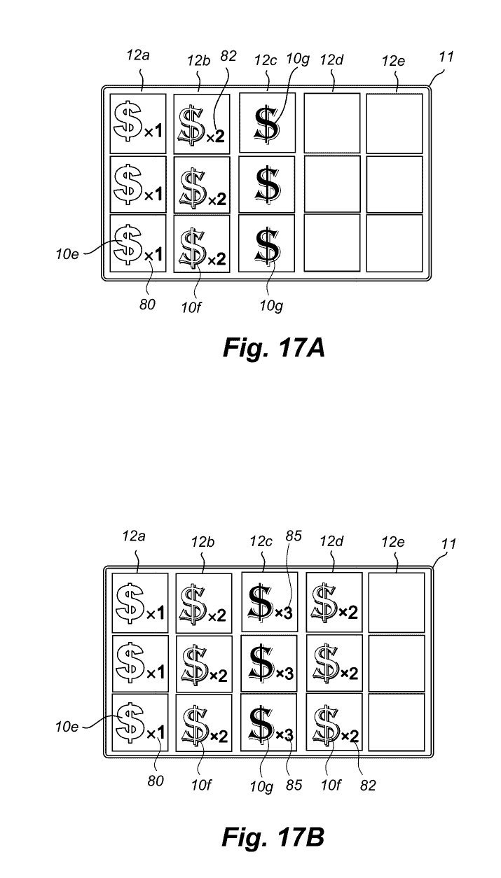

In a variation of this embodiment, the awarded multiplier values are shown to the player on the array 11, as best shown in FIGS. 17A and 17B. In this variation, the display of the bonus symbols 10e and 10f on reels 12a and 12b in FIG. 16A would be the same. However, after the respin of the remaining reels 12c to 12e, an “×1” image 80 is shown alongside the red bonus symbols 10e in reel 12a and an “×2” image 82 is shown alongside the green bonus symbols 10f in reel 12b, as best shown in FIG. 17A. The newly appearing blue bonus symbols 10g in reel 12c do not show a multiplier value so as to indicate which bonus symbols have newly appeared relative to the previously shown bonus symbols. In a further variation, the multiplier values are always shown to the player irrespective of when the bonus symbols 10e to 10g appear on the reels 12. As best shown in FIG. 7B, the array 11 shows the “×1” and “×2” images 80, 82 on reels 12a, 12b and 12e, while an “×3” image 85 is shown alongside the blue bonus symbols 10g in reel 12c. All the multiplier images 80, 82, 85 are shown for the stacked bonus symbols 10e to 10g, even though the blue bonus symbols 10g in reel 12c and the green bonus symbols in reel 12e have newly appeared in the play or spin of the array 11 while the bonus symbols 10e, 10f in reels 12a, 12b appeared in a previous spin of the array 11. In other embodiments, the multiplier images 80, 82, 85 are shown whenever the bonus symbols 10e to 10g appear, irrespective of whether they appear in a stack on the reels 12. Alternatively, the multiplier images 80, 82, 85 are shown only when the bonus symbols 10e to 10g appear in a stack on the reels 12.

In addition, while the embodiment has been described with reference to a feature game 9, it will be appreciated that the invention can be implemented in a base game 8. In this case, the appearance of stacked bonus symbols 10e to 10g on the reels 12 would not occur on free spins but in spins or plays of the base game 8 in response to bets made by the player. Also, the invention may be implemented in both a base game 8 and feature game 9, with bonus prizes of greater value in the feature game 9.

As briefly indicated above, the jackpots 23a to 23d offered by the electronic gaming machine 1 are standalone progressive jackpots. However, in other embodiments the jackpots 23 may be fixed jackpots, mystery jackpots, symbol driven jackpots and any combination thereof, including progressive jackpots (i.e. a mixture of different types of jackpots). In other embodiments, the jackpots 23a to 23d are limited to the base game 8. In further embodiments, the jackpots 23a to 23d are extended to include both the base game 8 and the feature game 9.

A progressive jackpot prize takes a portion of each bet (typically a set percentage of each bet) made on the electronic gaming machine and thus the amount of the progressive jackpot incrementally increases as more bets are made on the electronic gaming machine 1. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together.

The jackpot or bonus prizes may also be mystery jackpots rather than symbol driven jackpots. That is, none of the symbols in the game trigger the jackpot; hence the trigger event is a “mystery”. By way of comparison, a standard jackpot is typically symbol driven in that a particular combination of symbols must occur in the game to trigger the standard jackpot.

The trigger event for the mystery jackpot can be one randomly generated by the electronic game controller 4 for each play of the base game 8 and/or feature game 9. One way to implement the random determination of the trigger event is for the electronic game controller 4 to internally generate a random number and check if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur and award the progressive jackpot prize. It will be appreciated that this manner of determining the trigger event may also be used to determine whether the feature game 9 is triggered in the base game 8.

Progressive jackpots can be confined to the electronic gaming machine 1 as so called “standalone” progressive jackpots. Alternatively, the jackpot is a wide area or an in-house linked progressive jackpot prize. In other embodiments, one or more the progressive jackpot prizes are configured to be part of a wide area or in-house linked progressive jackpot prize. In other words, the progressive jackpot prizes can be awarded on a group of networked gaming machines in a specified area or a group of specified electronic gaming machines that are linked together for jackpot purposes (usually via a central jackpot controller). The jackpot prizes can also be shared with any other games offered on the same electronic gaming machine 1 (as in multi-game gaming machines).

During play of the base game 8 and/or feature game 9, the electronic game controller will determine whether a trigger event for any of the jackpots has occurred, as described above. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, their values are reset and game play of the electronic gaming machine 1 continues as before. The values of the jackpots that have been won can be reset either to a predetermined start value or simply increment upwardly from zero where the won jackpot is a progressive jackpot. In addition, contributions of portions of the bet made to play the game are only made for the jackpots that are active. In this way, the player's bets do not contribute towards jackpots that the player cannot win.

In other embodiments, the in-game trigger event is determined at the end or during the play of the game; i.e. at the end or during a spin of the reels 12. In some embodiments, the in-game trigger event occurs in a preceding play of the game so that the jackpot or other result of the in-game trigger event takes place in a subsequent play of said game, typically the next play of the game after said preceding play but could include a later successive play of the game.

In other embodiments, the electronic gaming machine 1 also offers the player the opportunity to play in community games against other players in so-called tournament games, or even in player versus player games. This is typically implemented by electronically linking several electronic gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in said selected available jackpot set.

It will be appreciated that in other embodiments, game enhancing elements can be awarded in the base game 8 or feature game 9 in addition or as an alternative to the prizes awarded based on winning combinations of game symbols. The award of game enhancing elements can be done by way of a sixth reel or the appearance of game enhancing symbols in the reels 12a to 12e. A variety of game enhancing elements can be awarded by the game enhancing symbols, including:
i) symbols that award a predetermined number of free plays of said game, such as 8, 10 or 15 free spins or games;
ii) win multiplier symbols that multiply the amount of any win from one of said predetermined winning combinations;
iii) “wild” symbols that cause the display of substitute symbols in randomly selected symbol positions;
iv) wild multiplier symbols that cause the display of substitute symbols on the array 11 and multiplies the amount of any win from one of said predetermined winning combinations;
v) bonus wild symbols that cause the display of substitute symbols on the array 11 and awards a bonus prize;
vi) symbols that cause the award of additional free plays of said game;
vii) symbols that cause one or more of said symbol positions to be held static (typically one or more reels 12a to 12e) and display substitute symbols on the array 11;
viii) symbols that cause the same game symbol to be stacked in a group of symbol positions, typically the group being one or more reels 12a to 12e;
ix) symbols that cause the display of new game symbols on the array 11;
x) “reveal” symbols that cause a game symbol to reveal another game symbol;
xi) “replacement” symbols that cause one or more game symbols to be replaced by other game symbols in the array 11;
xii) bonus prize of 5×bet, 10×bet or 25×bet (the total amount of the bet or credits bet per pay line);
xiii) all royal card symbols change to wilds (substitute symbols) on reels 12b, 12c and 12d (usually called reels 2, 3 and 4, respectively) of the array 11;
xiv) all picture symbols change to wilds on reels 2, 3 and 4 of the array 11;
xv) all symbols on reels 2 and 4 of the array 11 change to wild symbols; and
xvi) all symbols on reels 12a and 12e (usually called reels 1 and 5, respectively) of the array 11 change to wild symbols.

These game enhancing symbols do not modify the function or value of the game symbols 10 that appear on the array 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun reels 12. In another embodiment, the game enhancing symbols may indicate the duration in which its game enhancing element is applied, such as a predetermined number of spins or a predetermined time period.

While the same game format is essentially used across the base game 8 and feature game 9, it will be appreciated that the game format may vary across the base and feature games, as well as between base games where more than one game is offered by the same electronic gaming machine 1. For example, one of the base and feature games may be a wheel-type game or a four reel game and another of the base and feature games may be a standard five reel game. Similarly, the base and feature games may each have different game symbols, game rules and pay tables that are unique to each game.

While one embodiment of the invention has been described in relation to a base game 8 and a feature game 9, it will be appreciated that the invention could include one or more additional feature and/or bonus games that are triggered by specific trigger symbols appearing in the feature game 9. Also, the additional feature or bonus games may also have trigger symbols that trigger further feature or bonus games in a cascading fashion. These additional and further feature or bonus games could have the same game play elements as the feature game 9 or be different feature or bonus games entirely.

Furthermore, the embodiments of the invention have been described as providing a standard 5×3 set of reels 12 for the base game 8. However, it will be appreciated that in other embodiments, the size and shape of the reels 12 may vary for the base game 8 and/or the feature game 9. For example, the arrays 11 could take any number of different shapes, such as triangular, circular, square, hexagonal, hemi-spherical or other non-rectangular or polygonal shapes. In another example, where the array is circular, the symbol positions 13 can take the form of pie-shaped slices or wedges. Alternatively, the arrays 11 could have an unequal number of rows and/or columns. For example, the reels 12a, 12b could have three rows, but the reels 12c to 12e could have four rows.

In other embodiments, the base game 8 and the feature game 9 need not be displayed on a single video screen 7. Instead, they may be displayed on separate video screens, with the lower display area 7a appearing in a lower video screen and the upper display area 7b on an upper video screen. Also, the order can be reversed, with the base game 8 and/or feature game 9 appearing on an upper video screen or upper display area 7b of a single video display screen 7 and the information usually shown on the upper display area 7b appearing on a lower video screen or lower display area 7a of a single video display screen.

In another embodiment, the video screen 7 is a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the electronic gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10, such as the bonus symbols 10e, 10f, 10g, may appear in the reels 12.

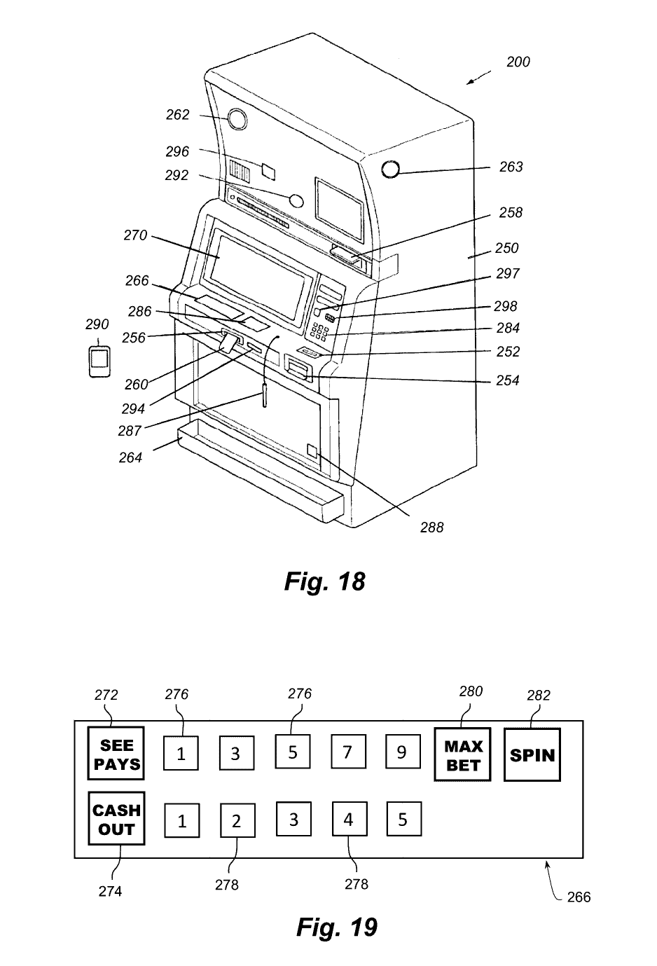

Referring to FIG. 18, another embodiment of the invention is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player. The topper (not shown) may be mounted to the top of the electronic gaming machine 200.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 200 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the players gaming habits, etc.

The electronic gaming machine 200 may include one or more audio speakers 262, a coin payout tray 264, an input control panel 266, and a colour video display unit 270 for displaying images relating to the game or games provided by the electronic gaming machine 200. The audio speakers 262 may generate audio representing sounds such as the noise of spinning reels, a dealers voice, music, announcements or any other audio related to a game. The input control panel 266 may be provided with a plurality of pushbuttons or touch-sensitive areas that may be pressed by a player to select games, make wagers, make gaming decisions, etc.

FIG. 19 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 20¢ could be wagered for each pay line selected, the maximum wager would be $1.80 The control panel 266 may include a spin button 282 to allow the player to initiate spinning of the reels after a bet has been made.

In FIG. 19, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a coloured area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297, and the scanner 297 may generate an electronic data representation of the fingerprint on one or more of the player's fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

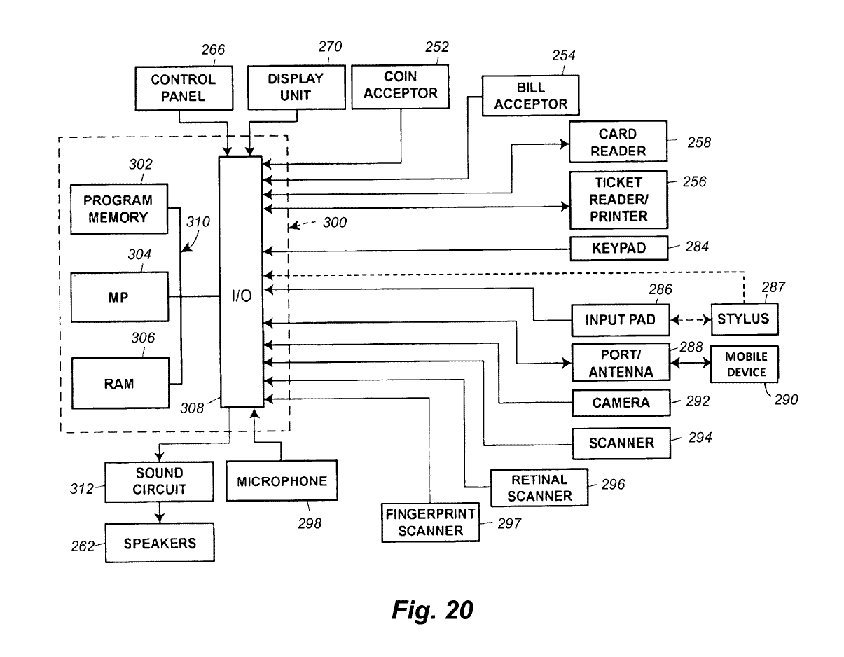

FIG. 20 is a block diagram of a number of components that may be incorporated in the electronic gaming machine 200. Referring to FIG. 20, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits. The RAM(s) 304 and program memories 302 may be implemented as semiconductor memories, magnetically readable memories, and/or optically readable memories, for example.

FIG. 20 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 20, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 12 may be connected to the I/O circuit 308 via a common bus or other data link that is shared by a number of components. Furthermore, some of the components may be directly connected to the microprocessor 304 without passing through the I/O circuit 308.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer programme configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory computer readable or carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the reels 12 and the feature of providing separate video screens for the lower display area 7a and upper display area 7b can be combined into a single electronic gaming machine 1. Similar combinations of two or more features from the above described embodiments or embodiments of the invention can be readily made by one skilled in the art.

By providing special game symbols that can appear in the game positions of the reels to trigger the award of a bonus prize which is dependent on the number of reels displaying the special game symbols, there is a higher chance of winning additional prizes and thus increasing the value won by the player in a play of the game. Thus, the invention retains the player interest and so the player is likely to continue playing the same electronic gaming machine. The player's anticipation and excitement is also heightened as he or she knows that a bonus prize will be awarded upon the appearance of special game symbols in stacks on the reels, and the value of the bonus prize depends on the number of reels with stacked special game symbols. Hence, the player will pay more attention to the visually indicated stacked special game symbols. The invention also adds greater value to a player in terms of the probability of winning a prize and providing greater variety in game play, especially compared to a conventional electronic gaming machine that only has one set of reels and a single feature game. This value to the player is increased in the preferred embodiments of the invention by including a respin of the reels that do not display the stacked special game symbols that increases the chance winning a bonus prize. All these advantages of the invention result in the player being more likely to retain interest in continuing to play the same electronic gaming machine due to the variation in game play on the electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a display for displaying a game, wherein said game comprises game positions arranged into a plurality of reels and predetermined winning combinations of randomly selected game symbols in said game positions award prizes to a player;
an electronic game controller for controlling the display of said game symbols on said display; and
value transfer mechanism for receiving value from a player to make a bet and initiate play of said game on said display;
wherein said electronic game controller in response to said player making a bet via said value transfer mechanism commences play of said game by randomly selecting game symbols and causing said display to display said randomly selected game symbols; and
wherein the appearance of special game symbols in the game positions of at least a predetermined number of reels causes said electronic game controller to award a bonus prize, said bonus prize being dependent on the number of reels that display said special game symbols in each of their respective game positions.

2. The electronic gaming machine of claim 1, wherein the value of said bonus prize increases as the number of said reels increases.

3. The electronic gaming machine of claim 1, wherein said predetermined number of reels is one.

4. The electronic gaming machine of claim 1, wherein said predetermined number of reels is two.

5. The electronic gaming machine of claim 1, wherein said bonus prize is awarded for adjacent reels having special game symbols displayed in their respective game positions.

6. The electronic gaming machine of claim 1, wherein said bonus prize is awarded for three reels having special game symbols displayed in their respective game positions.

7. The electronic gaming machine of claim 1, wherein said bonus prize is awarded for four reels having special game symbols displayed in their respective game positions.

8. The electronic gaming machine of claim 1, wherein said bonus prize is awarded for five reels having special game symbols displayed in their respective game positions.

9. The electronic gaming machine of claim 1, wherein there are different types of said special game symbols.

10. The electronic gaming machine of claim 9, wherein said bonus prize increases in value where said predetermined number of reels have the same type of special game symbol displayed in their respective game positions.

11. The electronic gaming machine of claim 9, wherein said bonus prize is awarded for at least three reels having the same type of special game symbol displayed in their respective game positions.

12. The electronic gaming machine of claim 9, wherein said bonus prize is awarded for at least four reels having the same type of special game symbol displayed in their respective game positions.

13. The electronic gaming machine of claim 9, wherein said bonus prize is awarded for at least five reels having the same type of special game symbol displayed in their respective game positions.

14. The electronic gaming machine of claim 9, wherein said special game symbols comprise differently colored special game symbols.

15. The electronic gaming machine of claim 1, wherein said bonus prize comprises a jackpot prize.

16. The electronic gaming machine of claim 1, wherein a trigger event causes said electronic game controller to respin one or more of said reels.

17. The electronic gaming machine of claim 16, wherein said trigger event comprises the appearance of said special game symbols in the game positions of said predetermined number of reels and said electronic game controller respins the other reels.

18. The electronic gaming machine of claim 17, wherein the appearance of said special game symbols in the game positions of a respun reel causes said electronic game controller to award a game enhancing element upon said player.

19. The electronic gaming machine of claim 18, wherein the appearance of said special game symbols in the game positions of a respun reel causes said electronic game controller to respin the other respun reels.

20. The electronic gaming machine of claim 18, wherein said game enhancing element comprises awarding the player with a free play of said game.

21. The electronic gaming machine of claim 1, wherein the appearance of said special game symbols in the game positions of one of said reels causes said electronic game controller to award a multiplier that increases the value of any prizes and/or bonus prizes awarded to said player.

22. The electronic gaming machine of claim 21, wherein the value of said multiplier depends on the type of said special game symbol.

23. The electronic gaming machine of claim 21, wherein an image corresponding to said multiplier is displayed adjacent to at least one of said special game symbols.
